(19) United States
(12) Patent Application Publication
(10) Pub. No.: US 2023/0292050 A1
(43) Pub. Date: Sep. 14, 2023

(54) LOUDSPEAKER DIAPHRAGM, LOUDSPEAKER, ELECTRONIC DEVICE, MOVABLE BODY, AND METHOD OF MANUFACTURING LOUDSPEAKER DIAPHRAGM

(71) Applicant: PANASONIC INTELLECTUAL PROPERTY MANAGEMENT CO., LTD., Osaka (JP)

(72) Inventors: Tetsuya KOYANAGI, Osaka (JP); Tetsushi ITANO, Osaka (JP); Kazuaki NISHIMURA, Osaka (JP)

(73) Assignee: PANASONIC INTELLECTUAL PROPERTY MANAGEMENT CO., LTD., Osaka (JP)

(21) Appl. No.: 18/116,182

(22) Filed: Mar. 1, 2023

(30) Foreign Application Priority Data
Mar. 11, 2022 (JP) 2022-037745

(51) Int. Cl. H04R 7/12; H04R 9/06; H04R 9/04; H04R 9/02; H04R 31/00; H04R 1/02

(52) U.S. Cl. CPC H04R 7/12; H04R 9/06; H04R 9/045; H04R 9/025; H04R 31/003; H04R 1/025; H04R 2307/023; H04R 2400/11; H04R 2201/028; H04R 2499/13

(57) ABSTRACT

A loudspeaker diaphragm that includes a resin containing silica derived from seed coats and a compatibilizer as an additive.

### CROSS REFERENCE TO RELATED APPLICATION

The present application is based on and claims priority of Japanese Patent Application No. 2022-037745 filed on Mar. 11, 2022.

### FIELD

The present disclosure relates to a loudspeaker diaphragm, a loudspeaker including the loudspeaker diaphragm, an electronic device, a movable body, and a method of manufacturing the loudspeaker diaphragm.

### BACKGROUND

Conventionally, for example, paper and resins are used as materials of a loudspeaker diaphragm. For example, Patent Literature (PTL) 1 proposes a loudspeaker diaphragm manufactured by kneading silica obtained by burning seed coats with resin without using a compatibilizer, and forming it into a loudspeaker diaphragm.

### CITATION LIST

### Patent Literature

PTL 1: Japanese Unexamined Patent Application Publication No. 2019-47151

### SUMMARY

However, the loudspeaker diaphragm according to PTL 1 can be improved upon.

In view of this, the present disclosure provides a loudspeaker diaphragm capable of improving upon the above related art.

A loudspeaker diaphragm according to one aspect of the present disclosure includes a resin containing silica derived from seed coats and a compatibilizer as an additive.

Moreover, a loudspeaker according to one aspect of the present disclosure includes: the loudspeaker diaphragm; a magnetic circuit; a frame that holds the magnetic circuit and the loudspeaker diaphragm; and a voice coil body including one end joined to the loudspeaker diaphragm and an other end disposed in a magnetic gap of the magnetic circuit.

Moreover, a method of manufacturing a loudspeaker diaphragm according to one aspect of the present disclosure includes: burning seed coats at a temperature of at least 300 degrees Celsius and at most 700 degrees Celsius to obtain amorphous silica; adding a compatibilizer to a thermoplastic resin containing the amorphous silica, kneading the compatibilizer and the thermoplastic resin, and producing pellets; and forming the pellets into a loudspeaker diaphragm to manufacture the loudspeaker diaphragm.

Moreover, an electronic device according to one aspect of the present disclosure includes: a loudspeaker that includes a loudspeaker diaphragm including a resin containing silica derived from seed coats and a compatibilizer as an additive, a magnetic circuit, a frame that holds the magnetic circuit and the loudspeaker diaphragm, and a voice coil body including one end joined to the loudspeaker diaphragm and an other end disposed in a magnetic gap of the magnetic circuit; and an amplifier circuit for an input signal to the loudspeaker.

Moreover, a movable body according to one aspect of the present disclosure includes: a loudspeaker that includes a loudspeaker diaphragm including a resin containing silica derived from seed coats and a compatibilizer as an additive, a magnetic circuit, a frame that holds the magnetic circuit and the loudspeaker diaphragm, and a voice coil body including one end joined to the loudspeaker diaphragm and an other end disposed in a magnetic gap of the magnetic circuit.

The loudspeaker diaphragm, the loudspeaker, the electronic device, the movable body, and the method of manufacturing the loudspeaker diaphragm according to the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a sectional view of a section of a loudspeaker diaphragm according to an embodiment.

FIG. 2 is a plan view of the loudspeaker diaphragm according to the embodiment.

FIG. 3 is a partially enlarged sectional view of the loudspeaker diaphragm according to the embodiment.

FIG. 4 is a diagram illustrating a method of manufacturing the loudspeaker diaphragm according to an embodiment.

FIG. 5 is a sectional view of a loudspeaker according to an embodiment.

FIG. 6 is a diagram illustrating an external view of an electronic device according to an embodiment.

FIG. 7 is a sectional view of a movable body according to an embodiment.

### DESCRIPTION OF EMBODIMENTS

Next, embodiments of a loudspeaker diaphragm, a loudspeaker, and a method of manufacturing the loudspeaker diaphragm according to the present disclosure will be described with reference to the drawings. Note that the following embodiments merely describe examples of the loudspeaker diaphragm, the loudspeaker, and the method of manufacturing the loudspeaker diaphragm according to the present disclosure. Therefore, the scope of the present disclosure is defined by the wording of the appended claims with reference to the following embodiments, and should not be limited to the following embodiments. Therefore, among the structural elements in the following embodiments, structural elements not recited in any one of the independent claims representing broadest concepts are not necessarily required to solve the problem, and are described as optional structural elements.

In addition, each of the drawings is a schematic representation of the present disclosure, with emphasis, omission, and/or adjustment of ratios as appropriate. The shapes, positional relationships, and ratios may differ from the actual shapes, positional relationships, and ratios.

The inventors have found that the silicone resin obtained by burning seed coats was difficult to form a thin loudspeaker diaphragm because silica obtained by burning seed coats has poor fluidity and was difficult to be dispersed uniformly in a resin. The present disclosure is based on the foregoing findings and provides a loudspeaker diaphragm that can be formed thin, an electronic device, a movable body, and a method of manufacturing the loudspeaker diaphragm.

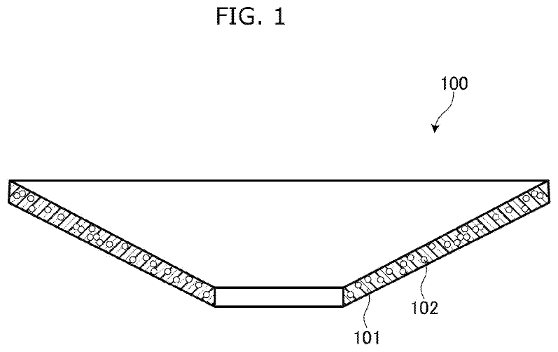

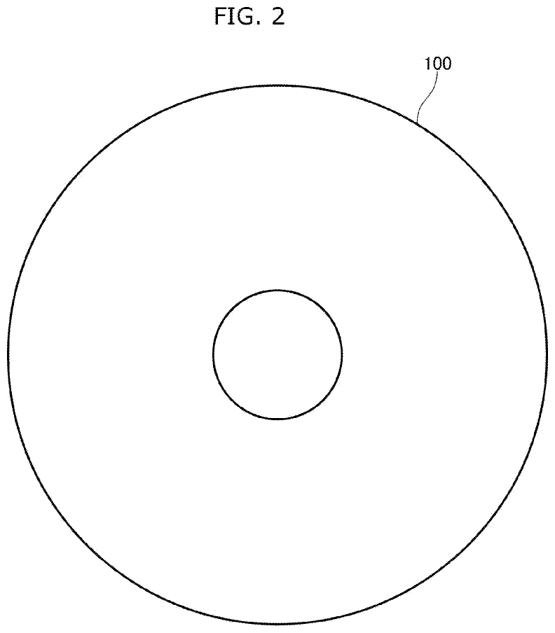

FIG. 1 is a sectional view of a section of a diaphragm according to an embodiment of the present disclosure. FIG. 2 is a plan view of the diaphragm according to the embodiment of the present disclosure. Loudspeaker diaphragm 100 is formed by kneading resin 101 to which a compatibilizer is added, with silica 102 derived from seed coats. In the present embodiment, loudspeaker diaphragm 100 is formed by mixing silica 102 derived from the seed coats into a thermoplastic resin raw material, kneading the material to which a compatibilizer is added and producing pellets, and injection-molding the pellets.

Loudspeaker diaphragm 100 may be of any shape. For example, the shape of loudspeaker diaphragm 100 may be not only a planar shape such as a disk shape or a quadrilateral plate, but also a three-dimensional shape such as a cone shape, as in the present embodiment.

Resin 101, a so-called matrix resin, which mainly constitutes loudspeaker diaphragm 100, may be any resin, and may be selected according to desired properties. Specifically, examples of resin 101 used for loudspeaker diaphragm 100 include crystalline olefin resins and amorphous olefin resins. Here, using an olefin resin such as polypropylene for loudspeaker diaphragm 100 can make loudspeaker diaphragm 100 thin because the olefin resin has good compatibility with the compatibilizer and improves formability. Moreover, using a crystalline resin or an amorphous resin according to applications makes it possible to satisfy optimal physical property values as a resin material. Note that the type of resin 101 is not limited to polypropylene, and biodegradable plastics represented by polylactic acid may be used for environmental consideration.

Silica 102 derived from the seed coats is a filler that adjusts the physical properties, such as density and stiffness, of loudspeaker diaphragm 100 formed from a resin. Containing silica 102 derived from the seed coats in resin 101 of loudspeaker diaphragm 100 makes it possible to reduce the weight of loudspeaker diaphragm 100. Moreover, the stiffness of loudspeaker diaphragm 100 can be increased and the flexural modulus can be adjusted. Furthermore, it is possible to make loudspeaker diaphragm 100 thinner compared with the case where loudspeaker diaphragm 100 is formed from a resin by forming empty chambers in loudspeaker diaphragm 100 by foaming. This further makes it possible to reduce the weight of loudspeaker diaphragm 100.

Silica 102 derived from the seed coats is amorphous silica obtained by burning the seed coats at a temperature of at least 300 degrees Celsius and at most 700 degrees Celsius. In the figures, silica 102 derived from the seed coats is depicted with white circles, but actually silica 102 retains shapes of at least part of the structural features of the seed coats. This is because the structures of the seed coats can be retained to some extent by burning the seed coats at a temperature of at least 300 degrees Celsius and at most 700 degrees Celsius and not grinding them. In addition, the fluidity at the time of forming loudspeaker diaphragm 100 can be improved by adding the compatibilizer to a thermoplastic resin containing silica 102 derived from the seed coats, which is obtained by burning the seed coats at a temperature of at least 300 degrees Celsius and at most 700 degrees Celsius. Accordingly, a thin loudspeaker diaphragm 100 can be easily formed.

Note that the temperature at which the seed coats are burned is preferably in a range of at least 400 degrees Celsius and at most 600 degrees Celsius. When the burning temperature is less than 400 degrees Celsius, a long burning time is required to produce silica 102, and this makes it difficult to produce silica 102 efficiently. Moreover, even when the burning is performed at a temperature exceeding 600 degrees Celsius, the properties of the obtained loudspeaker diaphragm 100 will not be improved and energy will be wasted. Therefore, it is undesirable.

Resin 101, which is included in loudspeaker diaphragm 100, contains a compatibilizer. The compatibilizer is an additive for increasing the compatibility between silica 102 and resin 101, such as a nonpolar resin, and effectively exerting the characteristics of silica 102. Hydrolyzable long-chain alkylsilane can be given as an example of the compatibilizer. A long-chain alkyl group included in hydrolyzable long-chain alkylsilane is structurally similar to an olefin resin such as polypropylene (PP), which is nonpolar. Therefore, hydrolyzable long-chain alkylsilane can increase compatibility with silica 102. Note that the compatibilizer is not limited to this example, and other so-called modified resins that have been modified and polarized with a silane coupling agent or maleic anhydride may be used.

In general, the additive amount of the compatibilizer is preferably in a range of from 0.1 wt % to 10 wt % with respect to resin 101. If the compatibilizer is too little, the effect cannot be obtained. On the other hand, if the compatibilizer is too much, it may deteriorate the physical properties of the diaphragm.

Any seed coats may be used as the seed coats. In the present embodiment, rice chaff is used. The rice chaff is a substance that is discarded when edible rice is produced, and is a material in line with the Sustainable Development Goals (SDGs). Note that examples of seeds other than rice include: seeds of gramineous crops, such as wheat, corn, barley, and rye, which are grain; seeds of leguminous crops, such as soybeans and adzuki beans; and seeds of polygonaceous crops, such as buckwheat. The coats include husks of rice and pods of beans.

The particle diameter of silica 102 is preferably less than or equal to 300 microns. When the rice chaff is burned at a temperature of at least 300 degrees Celsius and at most 700 degrees Celsius and not ground, the particle diameter of the obtained silica 102 is less than or equal to 300 microns.

When the mixing ratio of silica 102 is less than 1 wt %, the effects of silica 102 are hardly apparent as loudspeaker diaphragm 100. On the other hand, when the mixing ratio of silica 102 is greater than 50 wt %, loudspeaker diaphragm 100 will embrittle. In addition, even when the compatibilizer is added, the fluidity of the resin at the time of manufacture decreases, and this makes it difficult to make loudspeaker diaphragm 100 thin. Furthermore, the mixing ratio of silica 102 is preferably selected from a range of at least 10 wt % and at most 30 wt %.

Next, a method of manufacturing the loudspeaker diaphragm will be described. First, rice chaff is selected as the seed coats, and burned at a temperature of at least 300 degrees Celsius and at most 700 degrees Celsius. In the present embodiment, the burning temperature was controlled to around 600 degrees Celsius so that the burning temperature did not exceed 600 degrees Celsius. As a result, silica 102, which is porous low-temperature quartz with the shapes of the rice chaff remained, was generated. Silica 102 that was burned had a particle diameter of less than or equal to 300 μm.

Next, polypropylene is used as resin 101. Polypropylene is generally available and has a property of being easily injection molded.

Maleic anhydride-modified polypropylene (PP) is used as the compatibilizer. The additive amount of the compatibilizer was 5 wt % with respect to resin 101.

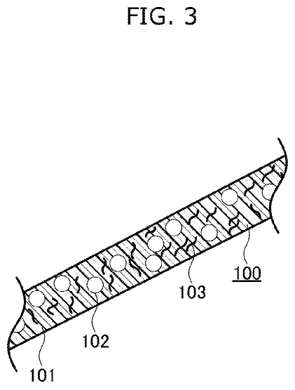

As illustrated in FIG. 3, reinforcement material 103 is added to resin 101 as a filler material in the present embodiment. When resin 101 and silica 102 are made into a composite material by reinforcement material 103, the effect of improving the strength of loudspeaker diaphragm 100 is effectively exerted, and the production efficiency and the quality improve.

Reinforcement material 103 is an additive contained in resin 101 to enhance loudspeaker diaphragm 100, stress sound, and adjust acoustic characteristics and sound quality by giving a peak in the sound pressure frequency characteristics. Reinforcement material 103 may be of any type. Examples of reinforcement material 103 include: a reinforcement material made of one type of material selected from mica, carbon fiber, aramid fiber, cellulose, fiberglass, and an inorganic fibrous material, or a reinforcement material obtained by combining two or more types of materials selected from mica, carbon fiber, aramid fiber, cellulose, fiberglass, and an inorganic fibrous material. Specifically, for example, mixing mica into reinforcement material 103 increases the stiffness and elastic modulus of loudspeaker diaphragm 100. As a result, it is possible to extend the upper frequency limit of the loudspeaker and achieve bright, well-modulated, high-quality sound.

Furthermore, by taking into account an unnecessary peak that is desired to be eliminated in the sound pressure frequency characteristics, a material having high internal loss, which has internal loss at a peak frequency, may be added.

The material having high internal loss is an additive that softens loudspeaker diaphragm 100 to generate internal loss, and adjusts sound pressure frequency characteristics in a direction that reduces the peak of the sound pressure frequency characteristics. The material having high internal loss may be of any type. Examples of the material having high internal loss include: a material made of one type of material selected from talc, calcium carbonate, and clay, or a material obtained by combining two or more types of the materials selected from talc, calcium carbonate, and clay.

As described above, resin 101, silica 102, reinforcement material 103, the compatibilizer, the material having high internal loss, and other materials to be added are selected by taking into account the density, elastic modulus, internal loss, and tone quality that are unique to each of these materials, a resonance frequency when each of these materials is formed into the shape of loudspeaker diaphragm 100, and so on.

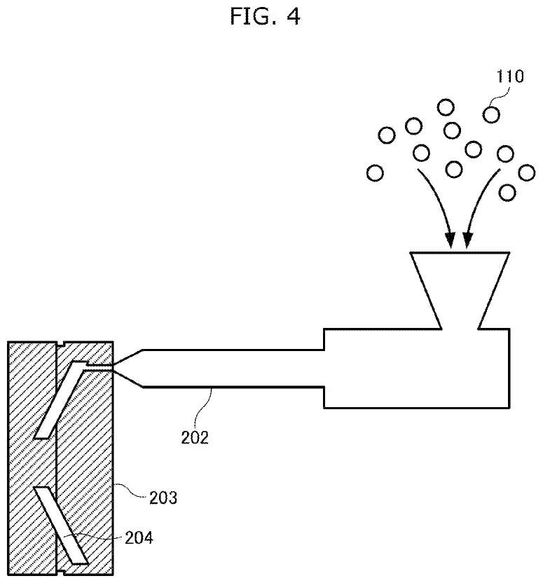

Next, as illustrated in FIG. 4, the content of silica 102 derived from rice chaff in resin 101 is adjusted to 30 wt %, and pellets 110 obtained by kneading 1 wt % of the compatibilizer and other reinforcement material 103 beforehand are injected into cavity 204 of mold 203 by injection molding machine 202. Accordingly, loudspeaker diaphragm 100 is formed.

The present disclosure uses pellets 110 obtained by kneading resin 101, which is polypropylene; silica 102 derived from rice chaff; the compatibilizer; and reinforcement material 103 to form loudspeaker diaphragm 100 by injection molding. This makes it possible to form a homogeneous and thin loudspeaker diaphragm 100.

Silica 102 can adjust the physical properties such as density and stiffness of loudspeaker diaphragm 100 formed from a resin.

It should be noted that thermal oxidation during kneading and molding may deteriorate the physical properties of the resin. Therefore, an antioxidant may be added to suppress such deterioration. The addition of an antioxidant prevents deterioration of the loudspeaker diaphragm. In other words, it is possible to maintain the excellent physical properties that the resin and silica 102 derived from the seed coats originally have and to achieve excellent acoustic characteristics and sound quality obtained by kneading them.

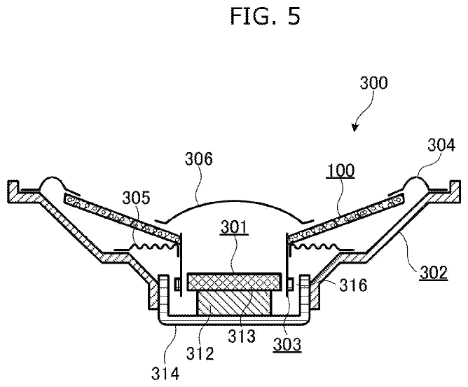

Next, loudspeaker 300 will be described. FIG. 5 is a sectional view of a loudspeaker according to an embodiment of the present disclosure. Loudspeaker 300 includes loudspeaker diaphragm 100, magnetic circuit 301, frame 302, and voice coil body 303.

Magnetic circuit 301 includes: magnet 312 having a cylindrical shape, which is a magnetized permanent magnet; plate 313 having a disk shape and mounted on the top portion of magnet 312; and yoke 314 having a bottomed cylindrical shape and storing magnet 312 and plate 313. Magnetic gap 316 having an annular shape is formed between plate 313 and yoke 314.

Frame 302 is a structural component that holds magnetic circuit 301 and loudspeaker diaphragm 100. Frame 302 may be of any shape. In the present disclosure, frame 302 has a funnel shape in an overall view. The outer periphery of loudspeaker diaphragm 100 is disposed at a position surrounded by the upper-end periphery of frame 302. Frame 302 and loudspeaker diaphragm 100 are bonded together via annular edge 304. Furthermore, center cap 306 is mounted to close a hole formed in the center of loudspeaker diaphragm 100.

Voice coil body 303 includes a cylindrical bobbin and a coil wound around the periphery of the bobbin, and is disposed such that one end is joined to the central part of loudspeaker diaphragm 100 and the other end is inserted into magnetic gap 316 of magnetic circuit 301. Furthermore, voice coil body 303 is supported by damper 305 that connects frame 302 and voice coil body 303 in a bridging manner.

A loudspeaker having magnetic circuit 301 of an internal magnet type has been described above. However, the present disclosure is not limited to this, and may be applied to a loudspeaker having a magnetic circuit of an external magnet type. Furthermore, loudspeaker 300 need not have damper 305.

This configuration makes it possible to exert the properties of loudspeaker diaphragm 100, and to increase the degree of freedom in adjusting sound quality by making loudspeaker diaphragm 100 thin. In addition, moisture resistant reliability and strength can be ensured, and a loudspeaker with excellent appearance and high productivity can be provided.

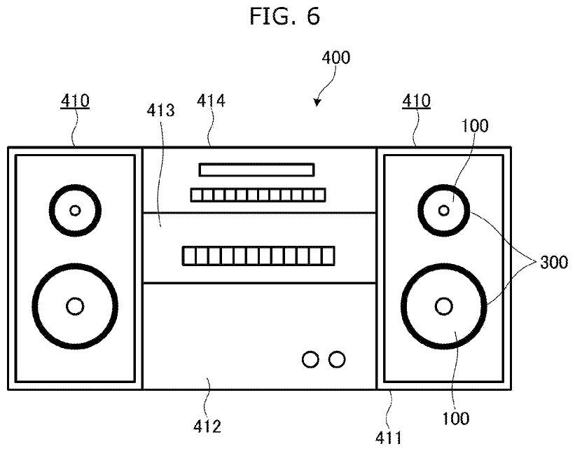

The following describes an electronic device to which the present disclosure is applicable. FIG. 6 is a diagram illustrating an external view of an electronic device, which is an embodiment of the present disclosure. In the present embodiment, a minicomponent audio system will be described as an example of electronic device 400.

Electronic device 400 includes loudspeaker systems 410 on the right and left sides, and each loudspeaker system 410 includes two loudspeakers 300 incorporated into enclosure 411.

Electronic device 400 also includes amplifier 412 that includes an amplifier circuit for an electric signal to be input to loudspeaker systems 410, and tuner 413 and compact disc (CD) player 414 that output sources to be input to amplifier 412.

Electronic device 400, which is a minicomponent audio system, amplifies a music signal input from tuner 413 or CD player 414 by amplifier 412, and emits sound from loudspeakers 300 provided in loudspeaker systems 410. Specifically, voice coil body 303 vibrates relative to frame 302 due to interaction between dynamic magnetic force generated by an electric signal input to voice coil body 303 and static magnetic force generated in magnetic gap 316 of magnetic circuit 301. This vibration is transmitted to loudspeaker diaphragm 100 and causes loudspeaker diaphragm 100 to vibrate, and loudspeakers 300 emit sound.

This configuration provides electronic device 400 capable of providing excellent and highly accurate characteristics, sound, and design, which have not been achieved by conventional devices, as described above.

Note that a minicomponent audio system has been described above as an application of loudspeaker 300 to electronic device 400, but the present disclosure is not limited to this example. For example, the present disclosure is applicable to audio systems for automobiles, portable audio devices, and the like. In addition, a wide variety of applications and developments are possible, including video devices such as liquid crystal televisions and organic electroluminescent (EL) display televisions, information communication devices such as mobile phones, and electronic devices such as computer-related devices.

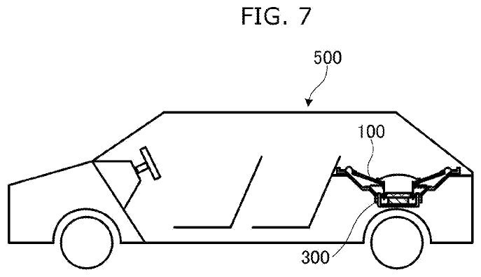

The following describes movable body 500 to which the present disclosure is applicable. FIG. 7 is a sectional view of a movable body, which is an embodiment of the present disclosure. In the present embodiment, an automobile will be described as an example of movable body 500.

As illustrated in the figure, loudspeaker 300 including loudspeaker diaphragm 100 according to the present disclosure is incorporated in a rear tray and/or a front panel of movable body 500. Loudspeaker 300 is configured to emit sound in the movable body based on an audio signal transmitted from a car navigation system or a car audio system, which are separately mounted to the movable body.

Loudspeaker diaphragm 100 mounted to movable body 500 as described above may be left in a severe environment such as an environment having a large temperature difference, a highly humid environment, and a dry environment. However, loudspeaker diaphragm 100 has high durability produced by taking advantage of the characteristics of loudspeaker diaphragm 100 formed from a resin and is capable of providing excellent and highly accurate characteristics, sound, and design.

It should be noted that the present disclosure should not be limited to the above embodiments. For example, another embodiment achieved by freely combining structural elements or excluding some structural elements described in this description may be included as an embodiment of the present disclosure. Furthermore, the present disclosure also includes variations obtained by various modifications to the foregoing embodiments that can be conceived by a person having ordinary skill in the art without departing from the scope of the essence of the present disclosure, that is, the intended meanings of the recitations of the claims.

For example, a surface of silica 102 to be mixed into resin 101 may be treated to improve adhesion to resin 101.

Moreover, silica 102 derived from the seed coats may be obtained not only by burning one type of coats, such as rice chaff. Silica 102 derived from the seed coats may also be obtained by burning multiple types of coats.

Furthermore, silica 102 obtained by burning may be ground to reduce the particle size. Furthermore, the particle size may be made uniform by classification.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent application including specification, drawings, and claims are incorporated herein by reference in their entirety: Japanese Patent Application No. 2022-037745 filed on Mar. 11, 2022.

### INDUSTRIAL APPLICABILITY

The loudspeaker diaphragm, the loudspeaker, and the method of manufacturing the loudspeaker diaphragm according to the present disclosure are applicable to electronic devices such as video and audio devices and information communication devices, and movable bodies such as automobiles.

1. A loudspeaker diaphragm comprising:
a resin containing silica derived from seed coats and a compatibilizer as an additive.

2. The loudspeaker diaphragm according to claim 1, wherein
a content of the silica derived from the seed coats in the resin is at least 1 wt % and at most 50 wt %, and
a content of the compatibilizer in the resin is at least 0.1 wt % and at most 10 wt %.

3. The loudspeaker diaphragm according to claim 1, wherein
the silica derived from the seed coats is amorphous silica obtained by burning the seed coats at a temperature of at least 300 degrees Celsius and at most 700 degrees Celsius.

4. The loudspeaker diaphragm according to claim 3, wherein
the silica derived from the seed coats is not ground after burning.

5. The loudspeaker diaphragm according to claim 1, wherein
the silica derived from the seed coats retains approximate shapes of the seed coats.

6. The loudspeaker diaphragm according to claim 1, wherein
the seed coats are chaff.

7. The loudspeaker diaphragm according to claim 1, wherein
a particle diameter of the silica derived from the seed coats is less than or equal to 300 microns.

8. The loudspeaker diaphragm according to claim 1, wherein
the compatibilizer is maleic anhydride-modified polypropylene (PP).

9. The loudspeaker diaphragm according to claim 1, wherein
the compatibilizer is hydrolyzable long-chain alkylsilane.

10. The loudspeaker diaphragm according to claim 1, wherein
the compatibilizer is a silane coupling agent.

11. The loudspeaker diaphragm according to claim 1, wherein
the compatibilizer is a modified resin that is modified with maleic anhydride.

12. A loudspeaker comprising:
the loudspeaker diaphragm according to claim 1;
a magnetic circuit;
a frame that holds the magnetic circuit and the loudspeaker diaphragm; and
a voice coil body including one end joined to the loudspeaker diaphragm and an other end disposed in a magnetic gap of the magnetic circuit.

13. A method of manufacturing a loudspeaker diaphragm, the method comprising:
burning seed coats at a temperature of at least 300 degrees Celsius and at most 700 degrees Celsius to obtain amorphous silica;
adding a compatibilizer to a thermoplastic resin containing the amorphous silica, kneading the compatibilizer and the thermoplastic resin, and producing pellets; and
forming the pellets into a loudspeaker diaphragm to manufacture the loudspeaker diaphragm.

14. An electronic device comprising:
the loudspeaker according to claim 12; and
an amplifier circuit for an input signal to the loudspeaker.

15. A movable body comprising:
the loudspeaker according to claim 12.
